(19) United States
(12) Patent Application Publication
(10) Pub. No.: US 2022/0410485 A1
(43) Pub. Date: Dec. 29, 2022

(54) SLICING 2D DATA-BASED PATTERN APPLICATION METHOD FOR REDUCING BINDER USAGE AMOUNT IN SAND BINDER JETTING

(71) Applicant: Korea Electronics Technology Institute, Seongnam-si (KR)

(72) Inventors: Hye In LEE, Anyang-si (KR); Sung Hun PARK, Seoul (KR); Hwa Seon SHIN, Yongin-si (KR); Sung Hwan CHUN, Seoul (KR); Jin Min JANG, Seoul (KR)

(73) Assignee: Korea Electronics Technology Institute, Seongnam-si (KR)

(21) Appl. No.: 17/780,206

(22) PCT Filed: Nov. 10, 2020
(86) PCT No.: PCT/KR2020/015679

§ 371 Date: May 26, 2022

(30) Foreign Application Priority Data
Nov. 29, 2019 (KR) 10-2019-0157559

(51) Int. Cl. B29C 64/386; B33Y 50/02; G06T 3/00

(52) U.S. Cl. CPC B29C 64/386; B33Y 50/02; G06T 3/0043; G06T 2207/20108

(57) ABSTRACT

Provided is a slicing 2D data-based pattern application method for generating an output code in which the inside of a model is filled with a pattern, so as to reduce a binder usage amount and maintain a strength and a shape in sand binder jetting additive manufacturing. A slicing 2D data-based pattern application method according to an embodiment of the present invention comprises the steps of: generating 2D data by slicing an output model; generating an inner pattern in at least one of layers forming an output model in consideration of the set thickness of the layers and the outer thickness thereof and generating an output code by applying the generated inner pattern. Therefore, the cost of producing an additive manufacturing output can be reduced by reducing the binder usage amount through the application of the inner pattern. In addition, reducing the binder usage amount enables a mold to be destroyed with less force than conventionally used, can increase the proportion of molding sand reuse by reducing the binder usage amount, and can reduce recovery treatment costs of the molding sand. Furthermore, casting defects due to increased ventilation can be reduced.

### TECHNICAL FIELD

The present disclosure relates to a technique for reducing a binder usage amount in sand binder jetting, and more particularly, to a technique which recognizes an additive model inside and applies a pattern to the inside in order to reduce a binder usage amount, and maintains strength and a shape of an output although the binder usage amount is reduced.

### BACKGROUND ART

Binder jetting in additive manufacturing refers to a method of building a shape by depositing by spraying a liquid adhesive and ink over a powdered material as shown in FIG. 1.

Such a binder jetting method has the merits of selecting a wide range of materials (plastic, ceramic, sand, metal, etc.), outputting a large component such as a sandcasting mold, a core, etc., outputting a complicated shape, not requiring a support, but has the demerit of having to perform post-processing to increase strength because strength decreases after outputting. The strength may be weak right after outputting a product (green body state), but the strength may be increased through a post-processing process for each material.

In particular, sand binder jetting is able to cast products of various sizes from small to large in the same way as existing sand casting, and furthermore, may fabricate a complicated shape that may not be fabricated by sand casting, and therefore, is in the spotlight in the manufacturing industry.

The sand casting has a great advantage over other casting methods in terms of economic feasibility since a cost for making a mold and a cost for destroying a used mold and reusing the mold as molding sand are relatively low.

In current sand casting, a cold box process using gas, etc. are developing in addition to an existing method of using heat to cure a mold, and sand binder jetting may be regarded as one of sand casting techniques for curing a mold by using a binder.

In general, the sand binder jetting method should fill an inside of an output model not to make an empty space.

For example, an output code may be made as shown in FIG. 2B, by slicing an output model shown in FIG. 2A. In this case, black portions appearing in the output code are areas onto which a binder is sprayed, and should be filled up 100% to be outputted.

Existing sand binder jetting manufacturers for commercial use may have a problem that there is no function of adjusting an amount of spray according to an output model or adjusting an amount of spray on the same layer like a gradation effect, besides a function of adjusting an amount of binder to be sprayed by changing equipment setting.

In addition, a mold made by sand binder jetting should endure pressure of molten metal poured into the inside thereof, and accordingly, there is an intention of outputting a rigid mold by spraying a binder sufficiently. However, there is difficulty in using an excessive amount of binder and in destroying a mold and reusing as molding sand.

Due to these disadvantages, the sand binder jetting method may increase a cost of production and may result in a problem that it is slowly introduced to an industrial site although it has many advantages over other methods.

Since strength of a mold made by sand binder jetting may vary according to a combination of molding sand and a binder, sand binder jetting may have price competitiveness by reducing a cost of production by reducing an amount of used binder in a combination that endures enough pressure of molten metal.

### DISCLOSURE

### Technical Problem

The present disclosure has been developed in order to address the above-discussed deficiencies of the prior art, and an object of the present disclosure is to provide a slicing 2D data-based pattern application method which can maintain a shape and strength in sand binder jetting, which is one of methods for making a mold and a core mold, and can also ensure competitiveness over other casting techniques, by reducing an amount of used binder by applying a slicing 2D data-based pattern.

### Technical Solution

According to an embodiment of the present disclosure to achieve the above-described object, a slicing 2D data-based pattern application method includes the steps of: generating 2D data by slicing an output model; generating an internal pattern on at least one of layers constituting the output mode, by considering a set thickness of the layer and a contour thickness; and generating an output code by applying the generated internal pattern.

In addition, according to an embodiment of the present disclosure, the slicing 2D data-based pattern application method may further include a step of determining whether to apply a pattern to each of the layers constituting the output model.

In addition, the step of determining whether to apply the pattern may include individually determining whether each of the layers corresponds to a bottom surface or a roof surface, by considering the set thickness of the layer and the contour thickness, so as to exclude a layer corresponding to the bottom surface or the roof surface among the layers constituting the output model when the pattern is applied.

In addition, the step of generating the internal pattern may include the steps of: extracting contour information by using surface slicing data with respect to a layer to which the pattern is applicable; reflecting a pre-set contour thickness on the extracted contour information; and generating the internal pattern by considering the reflected contour thickness.

In addition, the internal pattern may include a contour pattern which is formed in contact with an inner circumference of a contour, and a ratio pattern which is formed inside the contour pattern.

In addition, the internal pattern may be formed by generating the contour pattern in proportion to the contour thickness, and then generating the ratio pattern on the other portion.

In addition, the ratio pattern may be generated such that a filling ratio of the pattern is reduced toward a center of an inside.

In addition, the internal pattern may be implemented by a linear pattern in which a filling ratio of a pattern is adjusted according to a thickness of a line.

In addition, the internal pattern may be implemented by a figure pattern in which a filling ratio of a pattern is adjusted according to a size of a figure.

According to another embodiment of the present disclosure, a computer-readable recording medium has a computer program recorded thereon to perform a slicing 2D data-based pattern application method, the method including the steps of: generating 2D data by slicing an output model; generating an internal pattern on at least one of layers constituting the output mode, by considering a set thickness of the layer and a contour thickness; and generating an output code by applying the generated internal pattern.

In addition, according to another embodiment of the present disclosure, a slicing 2D data-based pattern application method includes the steps of: generating 2D data by slicing an output model; determining whether to apply a pattern to each of layers constituting the output model; extracting contour information by using surface slicing data; reflecting a pre-set contour thickness on the extracted contour information; generating an internal pattern by considering the reflected contour thickness; and generating an output code by applying the generated internal pattern.

In addition, according to another embodiment of the present disclosure, a computer-readable recording medium has a computer program recorded thereon to perform a slicing 2D data-based pattern application method, the method including the steps of: generating 2D data by slicing an output model; determining whether to apply a pattern to each of layers constituting the output model; extracting contour information by using surface slicing data; reflecting a pre-set contour thickness on the extracted contour information; generating an internal pattern by considering the reflected contour thickness; and generating an output code by applying the generated internal pattern.

### Advantageous Effects

According to embodiments of the present disclosure as described above, the unit cost of production of an additive manufacturing output may be reduced by reducing the binder usage amount through the application of the internal pattern.

In addition, according to embodiments of the present disclosure, due to the reduction of the binder usage amount, a mold may be destroyed with less force than in related-art methods, the proportion of molding sand reuse may be increased by reducing the binder usage amount, and recovery treatment costs of the molding sand may be reduced.

In addition, according to embodiments of the present disclosure, a casting defect caused by increased ventilation may be reduced

### DESCRIPTION OF DRAWINGS

FIG. 1 is a view provided to explain a related-art binder jetting additive manufacturing method;

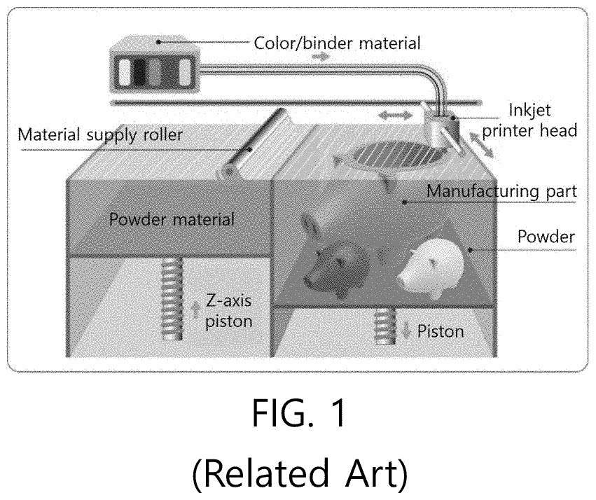

FIGS. 2A and 2B are views illustrating a mold and a core model for related-art sand casting, and an output code which is generated based on the mold and the core model;

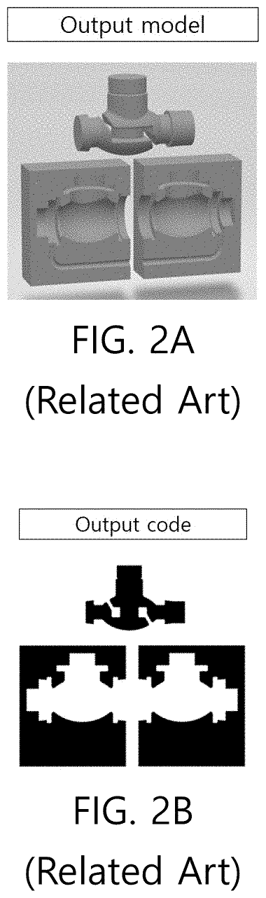

FIG. 3 is a view provided to explain a slicing 2D data-based pattern application method according to an embodiment of the present disclosure;

FIGS. 4A and 4B are views illustrating a 3D output model and slicing 2D data according to an embodiment of the present disclosure;

FIG. 5 is a view provided to explain a pattern application exception section when a pattern application layer is determined according to an embodiment of the present disclosure;

FIG. 6 is a view provided to explain a contour data generation process according to an embodiment of the present disclosure;

FIG. 7 is a view illustrating a state in which a contour thickness is reflected when contour data is generated according to an embodiment of the present disclosure;

FIG. 8 is a view illustrating a contour pattern and a ratio pattern when an internal pattern is generated according to an embodiment of the present disclosure;

FIGS. 9 and 10 are views illustrating an internal pattern according to an embodiment of the present disclosure; and

FIG. 11 is a view illustrating an output code according to an embodiment of the present disclosure.

### BEST MODE

Hereinafter, the present disclosure will be described in more detail with reference to the drawings.

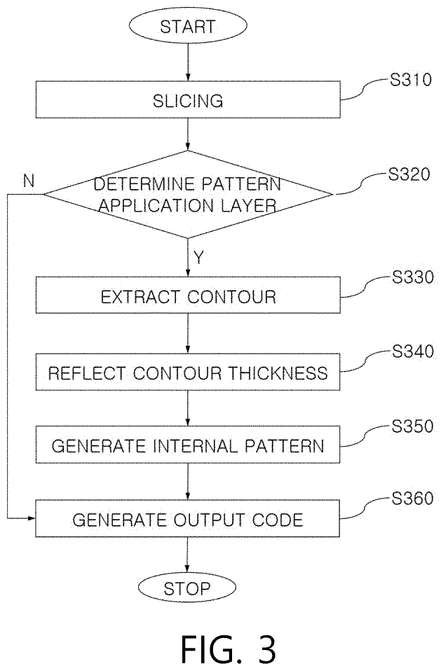

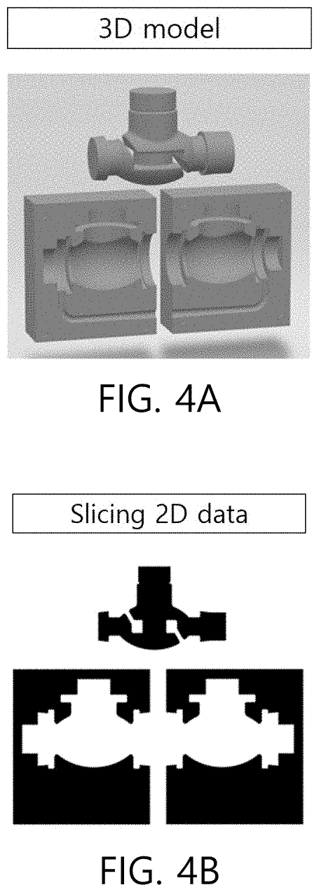

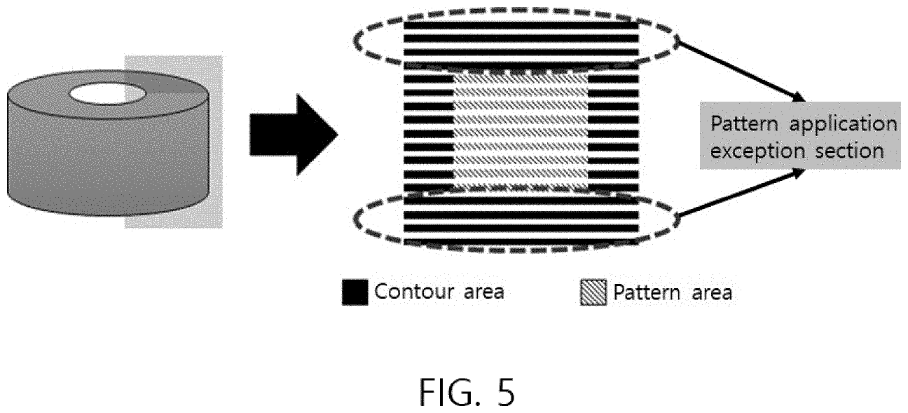

FIG. 3 is a view provided to explain a slicing 2D data-based pattern application method according to an embodiment of the present disclosure, FIG. 4 is a view illustrating a 3D output model and slicing 2D data according to an embodiment of the present disclosure, and FIG. 5 is a view provided to explain a pattern application exception section when a pattern application layer is determined according to an embodiment of the present disclosure.

The slicing 2D data-based pattern application method according to the present embodiment may generate an output code in which an inside of a model is filled with a pattern so as to reduce a binder usage amount and to maintain strength and a shape in sand binder jetting additive manufacturing.

To achieve this, the slicing 2D data-based pattern application method of the present disclosure may include a slicing step of generating 2D data by slicing an output model (S310), a pattern application layer determining step of determining whether to apply a pattern to each of the layers constituting the output model (S320), a contour extraction step of extracting contour information by using surface slicing data (S330), a contour thickness reflection step of reflecting a pre-set contour thickness on the extracted contour information (S340), an internal pattern generation step of generating an internal pattern on at least one of the layers constituting the output model by considering the reflected contour thickness (S350), and an output code generation step of generating an output code by applying the generated internal pattern (S360).

At the slicing step, D2 data as shown in FIG. 4B may be generated by slicing a 3D output model shown in FIG. 4A. In FIG. 4B, an area onto which a binder is sprayed is displayed in black, and a non-spraying area is displayed in white.

At the step of determining whether to apply a pattern, when a pattern is applied as shown in FIG. 5, it may be individually determined whether each layer corresponds to a bottom surface or a roof surface, by considering a set thickness of the layer and a contour thickness, in order to exclude layers corresponding the bottom surface and the roof surface among layers constituting the output model, and to apply a pattern only to a layer that does not correspond to the bottom surface and the roof surface.

In the case of the layer to which the pattern is not applied, an output code may be directly generated by using slicing 2D data.

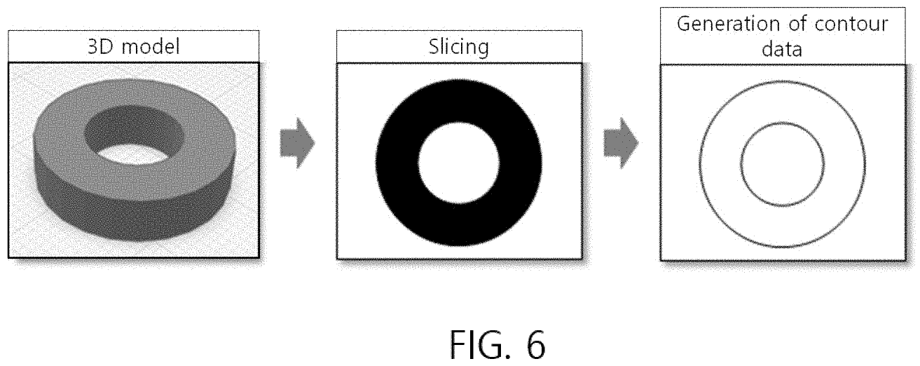

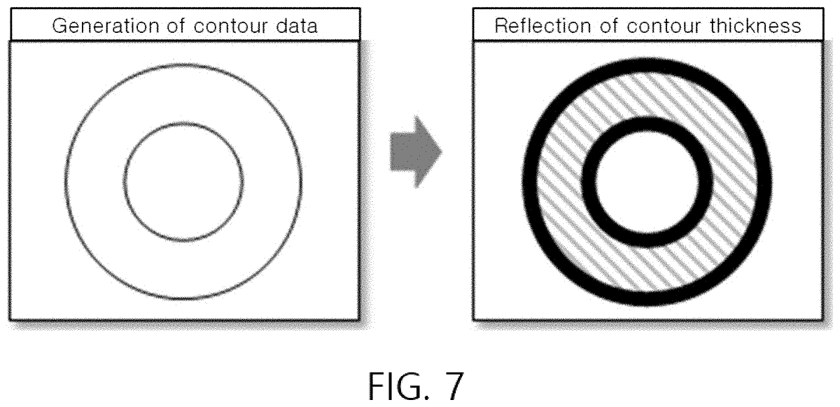

FIG. 6 is a view provided to explain a contour data generation process according to an embodiment of the present disclosure, and FIG. 7 is a view illustrating a state in which a contour thickness is reflected when contour data is generated according to an embodiment of the present disclosure.

At the contour extraction step, contour information may be extracted by using surface slicing data as shown in FIG. 6, and an inside and an outside of the sliced model may be distinguished.

At the contour thickness reflection step, a thickness set by a user may be reflected based on the acquired contour data. Portions remaining after the contour thickness is reflected is filled with A pattern, and the area filled with the pattern may correspond to the slashed area of FIG. 7.

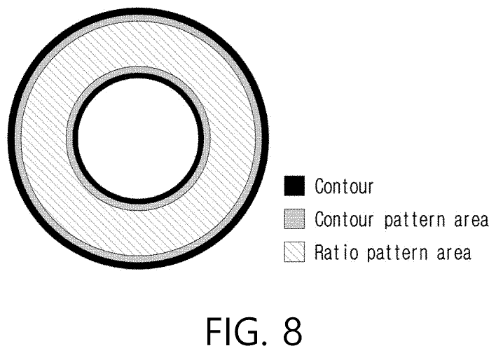

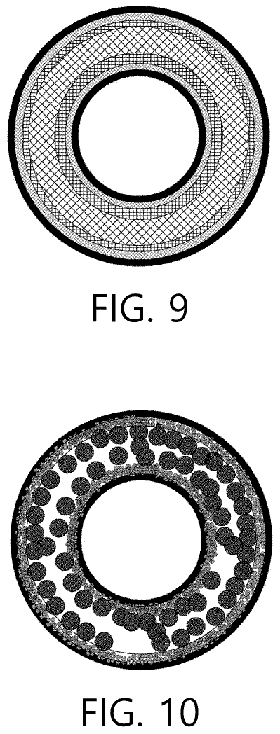

FIG. 8 is a view illustrating a contour pattern and a ratio pattern when an internal pattern is generated according to an embodiment of the present disclosure, and FIGS. 9 and 10 are views illustrating an internal pattern according to an embodiment of the present disclosure.

At the internal pattern generation step, an internal pattern may be generated on at least one of the layers constituting the output model by considering the reflected contour thickness.

In this case, the internal pattern may include a contour pattern which is formed in contact with an inner circumference of the contour, and a ratio pattern which is formed inside the contour pattern. The internal pattern may be generated by generating the contour pattern in proportion to the contour thickness and then generating the ratio pattern on the other portion.

For example, the contour pattern may be generated in a shape of being connected to the contour, and may be generated to have a size corresponding to a contour thickness set by the user, and may be generated at a fixed ratio of 90%.

The ratio pattern may be generated to have a filling ratio of the pattern reduced toward the center of the inside, and the internal pattern may be implemented by a linear pattern in which a filling ratio of a pattern is adjusted according to a thickness of a line as shown in FIG. 9, or a figure pattern in which a filling ratio of a pattern is adjusted according to a size of a figure as shown in FIG. 10.

For example, when the ratio pattern is implemented by the linear pattern, layers may be stacked with patterns of an upper layer and a lower layer being symmetrically rotated by 90 or 180 degrees.

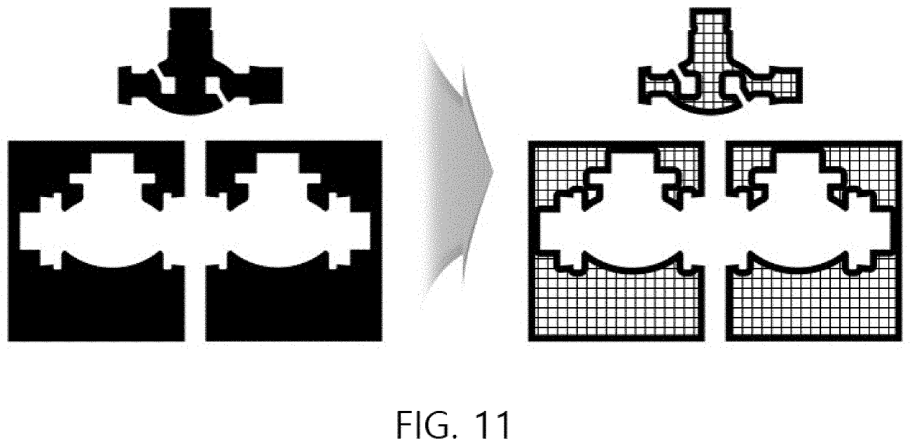

FIG. 11 is a view illustrating an output code according to an embodiment of the present disclosure. At the output code generation step, a final output code may be made by applying a pattern set by a user as shown in FIG. 11.

The unit cost of production of an additive manufacturing output may be reduced by reducing the binder usage amount through the application of the internal pattern. In addition, due to the reduction of the binder usage amount, a mold may be destroyed with less force than in related-art methods, the proportion of molding sand reuse may be increased by reducing the binder usage amount, and recovery treatment costs of the molding sand may be reduced. In addition, a casting defect caused by increased ventilation may be reduced.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A slicing 2D data-based pattern application method comprising the steps of:
generating 2D data by slicing an output model;
generating an internal pattern on at least one of layers constituting the output mode, by considering a set thickness of the layer and a contour thickness; and
generating an output code by applying the generated internal pattern.

2. The method of claim 1, further comprising a step of determining whether to apply a pattern to each of the layers constituting the output model.

3. The method of claim 2, wherein the step of determining whether to apply the pattern comprises individually determining whether each of the layers corresponds to a bottom surface or a roof surface, by considering the set thickness of the layer and the contour thickness, so as to exclude a layer corresponding to the bottom surface or the roof surface among the layers constituting the output model when the pattern is applied.

4. The method of claim 2, wherein the step of generating the internal pattern comprises the steps of:
extracting contour information by using surface slicing data with respect to a layer to which the pattern is applicable;
reflecting a pre-set contour thickness on the extracted contour information; and
generating the internal pattern by considering the reflected contour thickness.

5. The method of claim 4, wherein the internal pattern comprises a contour pattern which is formed in contact with an inner circumference of a contour, and a ratio pattern which is formed inside the contour pattern.

6. The method of claim 5, wherein the internal pattern is formed by generating the contour pattern in proportion to the contour thickness, and then generating the ratio pattern on the other portion.

7. The method of claim 6, wherein the ratio pattern is generated such that a filling ratio of the pattern is reduced toward a center of an inside.

8. The method of claim 5, wherein the internal pattern is implemented by a linear pattern in which a filling ratio of a pattern is adjusted according to a thickness of a line.

9. The method of claim 5, wherein the internal pattern is implemented by a figure pattern in which a filling ratio of a pattern is adjusted according to a size of a figure.

10. A computer-readable recording medium having a computer program recorded thereon to perform a slicing 2D data-based pattern application method, the method comprising the steps of:
generating 2D data by slicing an output model;
generating an internal pattern on at least one of layers constituting the output mode, by considering a set thickness of the layer and a contour thickness; and
generating an output code by applying the generated internal pattern.

11. A slicing 2D data-based pattern application method comprising the steps of:
generating 2D data by slicing an output model;
determining whether to apply a pattern to each of layers constituting the output model;
extracting contour information by using surface slicing data;
reflecting a pre-set contour thickness on the extracted contour information;
generating an internal pattern by considering the reflected contour thickness; and
generating an output code by applying the generated internal pattern.

12. A computer-readable recording medium having a computer program recorded thereon to perform a slicing 2D data-based pattern application method, the method comprising the steps of:
generating 2D data by slicing an output model;
determining whether to apply a pattern to each of layers constituting the output model;
extracting contour information by using surface slicing data;
reflecting a pre-set contour thickness on the extracted contour information;
generating an internal pattern by considering the reflected contour thickness; and
generating an output code by applying the generated internal pattern.
